(19) United States
(12) Patent Application Publication
(10) Pub. No.: US 2018/0272735 A1
(43) Pub. Date: Sep. 27, 2018

(54) INK CIRCULATION APPARATUS

(71) Applicant: TOSHIBA TEC KABUSHIKI KAISHA, Tokyo (JP)

(72) Inventor: Jun TAKAMURA, Mishima Shizuoka (JP)

(21) Appl. No.: 15/896,642

(22) Filed: Feb. 14, 2018

(30) Foreign Application Priority Data
Mar. 23, 2017 (JP) 2017-058177

(51) Int. Cl. B41J 2/175; B41J 2/20

(52) U.S. Cl. CPC B41J 2/17596; B41J 2/19; B41J 2/17563; B41J 2/20

(57) ABSTRACT

A liquid circulation apparatus includes a main tank that stores a liquid, an upstream tank connectable to an upstream side of an inkjet head, a downstream tank connectable to a downstream side of the inkjet head, a pump configured to supply the liquid from the main tank at an amount larger than a sum of an amount of liquid passing through the inkjet head and an amount of liquid ejected from the inkjet head. The upstream tank includes a first upstream liquid chamber configured to be at a hydrostatic position higher than a nozzle of the inkjet head and connected to the pump, a second upstream liquid chamber configured to be connected to the inkjet head, and a third upstream liquid chamber connected to the main tank. The downstream tank includes a first downstream liquid chamber configured to be at a hydrostatic position lower than the nozzle.

### CROSS-REFERENCE TO RELATED APPLICATION

This application is based upon and claims the benefit of priority from Japanese Patent Application No. 2017-058177, filed Mar. 23, 2017, the entire contents of which are incorporated herein by reference.

### FIELD

Embodiments described herein relate generally to an ink circulation apparatus.

### BACKGROUND

An ink circulation apparatus for circulating ink through an inkjet head is known. The ink circulation apparatus includes a main tank that stores ink, two tanks, one disposed upstream and one downstream of an inkjet head, a sensor that detects liquid levels in the two tanks, and a pump for circulating the ink.

The ink circulation apparatus adjusts the liquid levels of the two tanks by controlling the pump on the basis of the liquid levels detected by the sensor. In general, the ink circulation apparatus needs two pumps, one for supplying the ink from the main tank and one pump for circulating the ink within the ink circulation apparatus. Due to the need for more than one sensor and more than one pump, controlling the sensors and the pumps is cumbersome and a configuration of the ink circulation apparatus is complicated.

### DESCRIPTION OF THE DRAWINGS

FIG. 1 is a schematic diagram of an ink circulation apparatus according to an embodiment.

FIG. 2 is a diagram of an upstream tank in an ink circulation apparatus.

### DETAILED DESCRIPTION

In general, according to one embodiment, a liquid circulation apparatus includes a main tank that stores a liquid, an upstream tank connectable to an upstream side of an inkjet head, a downstream tank connectable to a downstream side of the inkjet head, a pump configured to supply the liquid from the main tank at an amount larger than a sum of an amount of liquid passing through the inkjet head and an amount of liquid ejected from the inkjet head. The upstream tank includes first, second, and third upstream liquid chambers, which are connected to an upstream air chamber, the first upstream liquid chamber configured to be at a hydrostatic position higher than a nozzle of the inkjet head, the second upstream liquid chamber being adjacent to the first upstream liquid chamber, and the third upstream liquid chamber being adjacent to the second upstream liquid chamber, an upstream supply port on the first upstream liquid chamber and connected to the pump, the upstream supply port being below an uppermost portion of the first upstream liquid chamber, an upstream delivery port on the second upstream liquid chamber and configured to be connected to the inkjet head, and an upstream drain port on the third upstream liquid chamber and connected to the main tank. The downstream tank includes a first downstream liquid chamber configured to be at a hydrostatic position lower than the nozzle and connectable to the inkjet head.

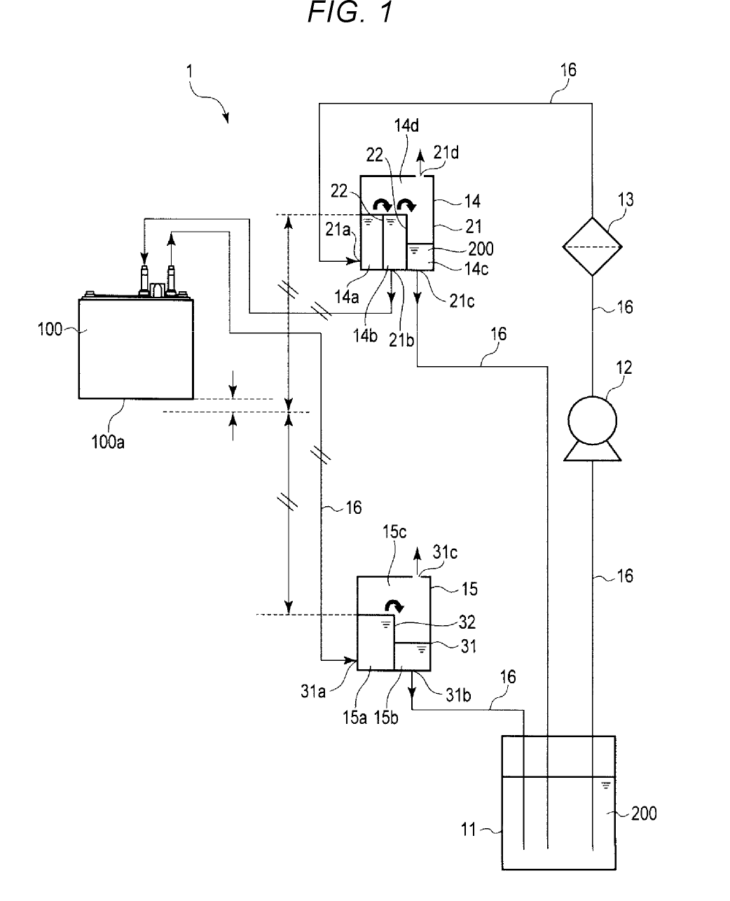

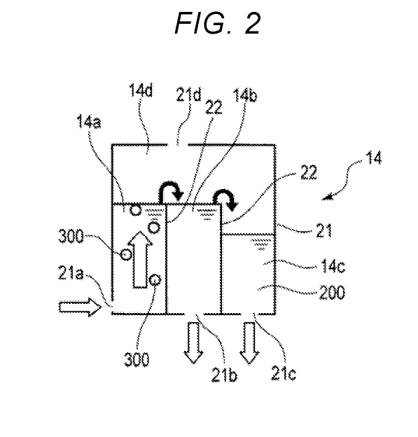

An ink circulation apparatus according to example embodiments will be described hereinafter with reference to FIGS. 1 and 2. It should be noted, that the particular embodiments explained below are some possible examples of an ink circulation apparatus according to the present disclosure and do not limit the possible configurations, specifications, or the like of reading apparatuses according to the present disclosure.

FIG. 1 is a schematic diagram of an ink circulation apparatus 1, and FIG. 2 is a diagram of an upstream tank 14 used in the ink circulation apparatus 1. In FIGS. 1 and 2, directional arrows on a circulation path indicated by tubes 16 and curved arrows indicate flows of ink 200 and flows of air 300, respectively.

As shown in FIG. 1, the ink circulation apparatus 1 includes a main tank 11, a pump 12, a filter 13, an upstream tank 14, and a downstream tank 15. An inkjet head 100 is disposed between the upstream tank 14 and the downstream tank 15 of the ink circulation apparatus 1. The ink circulation apparatus 1 includes tubes 16 that fluidly connect the main tank 11, the pump 12, the filter 13, the upstream tank 14, the downstream tank 15, and the inkjet head 100 and that configure a circulation route.

The inkjet head 100, the upstream tank 14, and the downstream tank 15 at predetermined heights as to provide a desired amount of the ink 200 passing through the inkjet head 100 that is determined depending on liquid level (hydrostatic head) differences among a nozzle surface 100a of the inkjet head 100, the upstream tank 14, and the downstream tank 15. In addition, a surface pressure of the ink, that is, a meniscus of the ink on the nozzle surface 100a is determined depending on a fixed positional relationship among the nozzle surface 100a, the upstream tank 14, and the downstream tank 15.

Specifically, the ink circulation apparatus 1 is configured such that the liquid level of the downstream tank 15 is above a liquid level of the main tank 11, the nozzle surface 100a is above the liquid level of the downstream tank 15, and the liquid level of the upstream tank 14 is above the nozzle surface 100a. Furthermore, the ink 200 that is not ejected from the inkjet head 100 falls into the downstream tank 15 by a liquid level difference between the upstream tank 14 and the downstream tank 15.

The inkjet head 100 includes a plurality of nozzles on the nozzle surface 100a. The inkjet head 100 is adjusted in such that the meniscus of the ink 200 in each nozzle on the nozzle surface 100a has a predetermined shape depending on the height of the inkjet head 100.

The main tank 11 stores the ink 200.

A suction side, that is, a primary side of the pump 12 is connected to the main tank 11 via the tube 16. The pump 12 delivers the ink 200 in the main tank 11 to a secondary side of the pump 12. The pump 12 has a capability supplying the secondary side of the pump 12 with an amount of the ink 200 that is larger than a sum of an amount of the ink 200 passing through the inkjet head 100 and an amount of the ink 200 ejected from the inkjet head 100.

A primary side of the filter 13 is connected to the pump 12 via the tube 16.

The upstream tank 14 has three liquid chambers 14a, 14b, and 14c and a space (also referred to as an air chamber or an upstream air chamber) 14d that is connected to upper portions of each of the liquid chambers (14a, 14b, and 14c) and is also open to atmospheric air. In the upstream tank 14, a portion of the tube 16 connected to the pump 12 is connected to a lower portion of a first liquid chamber 14a, a portion of the tube 16 connected to the inkjet head 100 is connected to a lower portion of a second liquid chambers 14b which adjoins the first liquid chamber 14a, and a portion of the tube 16 connected to the main tank 11 is connected to a lower portion of a third liquid chamber 14c that adjoins the second liquid chamber 14b.

In an example embodiment depicted in FIG. 2, the upstream tank 14 includes a rectangular parallelepiped tank main body 21 and two upstream partition plates 22 that partition the tank main body 21 into three liquid chambers (also referred to as upstream liquid chambers) 14a, 14b, and 14c arranged side by side along one direction. The two upstream partition plates 22 are, for example, identical in shape. The two upstream partition plates 22 are each configured to have a height lower than the height of an internal space of the tank main body 21.

The tank main body 21 has an upstream supply port 21a on a lower end of a side wall, to which, for example, a portion of the tube 16 connected to a secondary side of the filter 13 is connected. The tank main body 21 has an upstream delivery port 21b and an upstream drain port 21c that are separated by the two upstream partition plates 22. The upstream delivery port 21a and the upstream drain port 21c are provided at positions, on a bottom surface, corresponding to the second and third liquid chambers 14b and 14c, respectively. The tank main body 21 has an opening 21d that is provided on either the side wall or a top wall above the upstream partition plates 22 of the tank main body 21 and is open to atmosphere.

The two upstream partition plates 22 are disposed within the tank main body 21. The two upstream partition plates 22 divide the internal space of the tank main body 21, thereby forming the first liquid chamber 14a, the second liquid chamber 14b, the third liquid chamber 14c, and an air chamber 14d that is connected to the liquid chambers 14a, 14b, and 14c within the tank main body 21.

The first upstream liquid chamber 14a is formed by the tank main body 21 and one of the upstream partition plates 22. A side lower end of the first upstream liquid chamber 14a is connected to the upstream supply port 21a. The second upstream liquid chamber 14b is formed by the tank main body 21 and the two upstream partition plates 22. A bottom portion of the second upstream liquid chamber 14b is connected to the upstream delivery port 21b. The third upstream liquid chamber 14c is formed by the tank main body 21 and the other upstream partition plate 22. A bottom portion of the third upstream liquid chamber 14c is connected to the upstream drain port 21c. The upstream air chamber 14d is open to atmosphere via the opening 21d.

The downstream tank 15 includes a rectangular parallelepiped tank main body 31 and one downstream partition plate 32 that divides the tank main body 31 into two liquid chambers (also referred to as downstream liquid chambers) 15a and 15b arranged side by side.

The tank main body 31 has a downstream supply port 31a on a lower end of a side wall, to which, for example, a portion of the tube 16 connected to a secondary side of the inkjet head 100 is connected. The tank main body 31 has a downstream drain port 31b that is provided at a position, on a bottom surface, corresponding to the liquid chamber 15b. The tank main body 31 has an opening 31c that is provided on either the side wall or a top wall above the downstream partition plate 32 and connected to the atmosphere. The downstream partition plate 32 is configured to have a height lower than the full height of the internal space of the tank main body 31.

The downstream partition plate 32 is disposed within the tank main body 31 and partitions the internal space of the tank main body 31 into two spaces, thereby forming the first downstream liquid chamber 15a, the second downstream liquid chamber 15b, and a downstream air chamber 15c that is connected to these liquid chambers 15a and 15b within the tank main body 31.

The first downstream liquid chamber 15a is formed by the tank main body 31 and the downstream partition plate 32. A side lower end of the first downstream liquid chamber 15a is connected to the downstream supply port 31a. The second downstream liquid chamber 15b is formed by the tank main body 31 and the downstream partition plate 32. A bottom portion of the second downstream liquid chamber 15b is connected to the downstream drain port 31b. The downstream air chamber 15c is open to atmosphere via the opening 31c.

Preferably, the portion of the tube 16 that connects the upstream tank 14 to the inkjet head 100 and the portion of the tube 16 that connects the inkjet head 100 to the downstream tank 15 are identical in length and diameter for the following reasons. The amount of the ink 200 passing through the inkjet head 100 is determined depending on a liquid surface pressure difference. Therefore, a pressure loss due to the tubes 16 can be ignored even when a flow rate changes.

The pump 12 delivers the ink 200 from the main tank 11 to the secondary side of the pump 12 in response to a command of driving. The ink 200 is delivered by the pump 12 and impurities in the ink 200 are removed by the filter 13. The ink 200 further circulates from the upstream supply port 21a to the first upstream liquid chamber 14a via the tube 16.

The ink 200 moves into the first upstream liquid chamber 14a upward from below the first upstream liquid chamber 14a and then to the second upstream liquid chamber 14b by flowing over the upstream partition plate 22 between the first upstream liquid chamber 14a and the second upstream liquid chamber 14b. The ink 200 then moves to the third upstream liquid chamber 14c by flowing over the upstream partition plate 22 between the second upstream liquid chamber 14b and the third upstream liquid chamber 14c.

A part of the ink 200 moving into the second upstream liquid chamber 14b flows to the inkjet head 100 via the upstream delivery port 21b and the tube 16. The remainder of the ink 200 moving into the second upstream liquid chamber 14b moves to the third upstream liquid chamber 14c, and then moves from the third upstream liquid chamber 14c to the main tank 11, which functions here as a drain, via the upstream drain port 21c and the tube 16.

That is, the pump 12 supplies the ink 200 at a flow rate exceeding volume capacities of the first upstream liquid chamber 14a and the second upstream liquid chamber 14b, and the first upstream liquid chamber 14a and the second upstream liquid chamber 14b are constantly in an overflow state.

The flow of the ink 200 moving from the first upstream liquid chamber 14a to the second upstream liquid chamber 14b matches the flow of the ink 200 moving upward from below. The air 300 contained in the ink 200 also moves upward, together with the ink 200, and moves from the liquid level of the first upstream liquid chamber 14a into the upstream air chamber 14d. That is, the upstream supply port 21a, the first upstream liquid chamber 14a, and the upstream air chamber 14d function as a trap that removes air 300 from the ink 200.

A part of the ink 200 flowing to the inkjet head 100 is delivered or ejected from the nozzles on the nozzle surface 100a. The portion of the ink 200 that is not expelled from the nozzles moves to the downstream tank 15 via the tube 16 connected to the secondary side of the inkjet head 100.

The ink 200 moving to the downstream tank 15 flows from the downstream supply port 31a of the tank main body 31 to the first downstream liquid chamber 15a.

The ink 200 moving to the first downstream liquid chamber 15a flows upward from below in the first downstream liquid chamber 15a. The ink 200 flowing upward in the first downstream liquid chamber 15a then moves to the second downstream liquid chamber 15b by flowing over the downstream partition plate 32 that separates the first downstream liquid chamber 15a and the second downstream liquid chamber 15b.

The ink 200 moving to the second downstream liquid chamber 15b then flows to the main tank 11, which here functions as a drain, via the downstream drain port 31b and the tube 16. The flow of the ink 200 moving from the first downstream liquid chamber 15a to the second downstream liquid chamber 15b is a flow of the ink 200 moving upward from below, so air 300 contained in the ink 200 moves to the downstream air chamber 15c. That is, the downstream supply port 31a, the first downstream liquid chamber 15a, and the downstream air chamber 15c function as a trap that removes air 300 from the ink 200.

The ink 200 flowing from the upstream tank 14 and the downstream tank 15 to the main tank 11 is then drawn into the pump 12 again and delivered from the pump 12. In this way, the ink circulation apparatus 1 circulates the ink 200 and also supplies the ink 200 to the inkjet head 100.

In the ink circulation apparatus 1 configured as described above, the upstream tank 14 and the downstream tank 15 are configured to cause the ink 200 to flow in an upward direction in the first liquid chambers 14a and 15a, whereby the air chambers 14d and 15c can trap air 300 that might be contained in the ink 200. Thus, it is possible to prevent the ink 200 that is being supplied to the inkjet head 100 (located on a secondary side of the upstream tank 14) from containing air bubbles (air 300). It is also possible to prevent the portion of the ink 200 that is discharged from the drain ports 21c and 31b and returns to the main tank 11 from containing air 300.

The ink circulation apparatus 1 can thus stably supply the ink 200 to the inkjet head 100. Specifically, it is possible to prevent the air bubbles from causing faulty ink/liquid delivery when the ink 200 is expelled from the nozzles of the inkjet head 100. The ink circulation apparatus 1 can therefore improve a quality of printed matter being printed by a printer that incorporates the ink circulation apparatus 1 and the inkjet head 100 and can prevent occurrences of printing failures such as a blurred printing. The ink circulation apparatus 1 can improve reliabilities of the inkjet head 100 and the printer.

Furthermore, even when ink includes pigments or other components that are prone to settling as the ink 200 is used, because the ink 200 moves upward from a bottom surface side of the upstream tank 14. The ink circulation apparatus 1 can prevent the pigments and other ink components from settling at the bottom of the first upstream liquid chamber 14a.

The upstream tank 14 and the downstream tank 15 can trap the air 300, so that the ink circulation apparatus 1 can prevent the ink 200 returning to the main tank 11 from containing the air 300.

Ink 200 moving into the downstream tank 15, in particular, may first pass through the inkjet head 100. Even when the air 300 is drawn in from the nozzles and the air 300 penetrates into the ink 200 by driving the inkjet head 100, the downstream tank 15 can trap the air 300 contained in the ink 200 Thus, it is possible to prevent a content of the air 300 in the ink 200 from increasing and the stable delivery of the ink 200 from the inkjet head 100 may be consistently provided using the ink circulation apparatus 1.

In the ink circulation apparatus 1, it is possible to specify the amount of the circulating ink 200 and the pressure of the ink 200 on the nozzle surface 100a by one pump 12 by trapping the air 300 in the upstream tank 14 and the downstream tank 15. The ink circulation apparatus 1 requires a small number of components and may be made in a simple configuration. The ink circulation apparatus 1 uses the pump 12 configured such that the amount of the ink 200 supplied to the secondary side of the pump 12 is set larger than the sum of the amount of the ink 200 supplied to the inkjet head 100 and the amount of the ink 200 delivered from the inkjet head 100. Thus, the ink circulation apparatus 1 may control only one pump 12 and can simplify control processing.

As described above, the ink circulation apparatus 1 according to the example embodiment described above is simple in the configuration and can simplify control processing.

It is noted that the configuration of the ink circulation apparatus 1 is not limited to the configuration described above. In the example embodiment described above, the upstream tank 14 and the downstream tank 15 of the ink circulation apparatus 1 function to trap the air 300, but a configuration of the ink circulation apparatus 1 is not limited to this example. For example, the ink circulation apparatus 1 may be configured such that only the upstream tank 14 has a function of trapping the air 300. However, in general, the ink circulation apparatus 1 is preferably configured such that each of the upstream tank 14 and the downstream tank 15 has the ability to trap the air 300.

In the example embodiment described above, the supply port 21a of the upstream tank 14 and the supply port 31a of the downstream tank 15 are both disposed on the lower end sides of the first liquid chambers 14a and 15a, respectively, but the configuration of the ink circulation apparatus 1 is not limited to this example. The supply ports 21a and 31a may be disposed on bottom-side ends of the first liquid chambers 14a and 15a or may be disposed above the lowermost ends. That is, positions of the supply ports 21a and 31a can be set varied so long as flow passages for the ink 200 extending upward from the supply ports 21a and 31a to the liquid levels of the first liquid chambers 14a and 15a in a gravity direction are provided sufficiently and the air chambers 14a and 15c connected to the atmospheric air are still disposed above the liquid levels. However, in general, it is preferable that lengths from the supply ports 21a and 31a to the liquid levels of the first liquid chambers 14a and 15a in the gravity direction are as large as possible in the light of intended functions of the upstream tank 14 and the downstream tank 15 for trapping the air 300 in the ink 200.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. A liquid circulation apparatus, comprising:
a main tank that stores a liquid;
an upstream tank connectable to an upstream side of an inkjet head;
a downstream tank connectable to a downstream side of the inkjet head; and
a pump configured to supply the liquid from the main tank in an amount larger than a sum of an amount of liquid passing through the inkjet head and an amount of liquid ejected from the inkjet head, wherein
the upstream tank includes:
first, second, and third upstream liquid chambers, which are connected to an upstream air chamber, the first upstream liquid chamber configured to be at a hydrostatic position higher than a nozzle of the inkjet head, the second upstream liquid chamber being adjacent to the first upstream liquid chamber, and the third upstream liquid chamber being adjacent to the second upstream liquid chamber;
an upstream supply port on the first upstream liquid chamber and connected to the pump, the upstream supply port being below an uppermost portion of the first upstream liquid chamber;
an upstream delivery port on the second upstream liquid chamber and configured to be connected to the inkjet head; and
an upstream drain port on the third upstream liquid chamber and connected to the main tank, and
the downstream tank includes a first downstream liquid chamber configured to be at a hydrostatic position lower than the nozzle and connectable to the inkjet head.

2. The ink circulation apparatus according to claim 1, wherein the upstream supply port is on a side wall of the first upstream liquid chamber.

3. The ink circulation apparatus according to claim 1, wherein the upstream tank includes an upstream partition plate that separates the first upstream liquid chamber and the second upstream liquid chamber.

4. The ink circulation apparatus according to claim 1, wherein the downstream tank further includes:
a second downstream liquid chamber connected to the first downstream liquid chamber;
a downstream air chamber that is connected to the first downstream liquid chamber and the second downstream liquid chamber;
a downstream supply port on the first downstream liquid chamber and configured to be connected to the inkjet head; and
a downstream drain port on the second downstream liquid chamber and connected to the main tank.

5. The ink circulation apparatus according to claim 4, wherein
the downstream tank includes a partition plate that separates the downstream tank into the first downstream liquid chamber and the second downstream liquid chamber, and
the downstream supply port is disposed on a side wall of the first downstream liquid chamber.

6. The ink circulation apparatus according to claim 1, wherein a connector tube for fluidly connecting the upstream tank to the inkjet head and a connector tube for fluidly connecting the inkjet head to the downstream tank are identical in length and diameter.

7. The ink circulation apparatus according to claim 1, further comprising a filter connected between the pump and the first upstream liquid chamber, the filter being configured to remove impurities from liquid.

8. An ink ejecting apparatus, comprising:
an inkjet head having a nozzle;
a main tank that stores ink;
an upstream tank connected to an upstream side of the inkjet head;
a downstream tank connected to a downstream side of the inkjet head;
a pump configured to supply the liquid from the main tank at an amount larger than a sum of an amount of liquid passing through the inkjet head and an amount of liquid ejected from the inkjet head, wherein
the upstream tank includes:
first, second, and third upstream liquid chambers, which are connected to an upstream air chamber, the first upstream liquid chamber configured to be at a hydrostatic position higher than a nozzle of the inkjet head, the second upstream liquid chamber being adjacent to the first upstream liquid chamber, and the third upstream liquid chamber being adjacent to the second upstream liquid chamber;
an upstream supply port on the first upstream liquid chamber and connected to the pump, the upstream supply port being below an uppermost portion of the first upstream liquid chamber;
an upstream delivery port on the second upstream liquid chamber and connected to the inkjet head; and
an upstream drain port on the third upstream liquid chamber and connected to the main tank, and
the downstream tank includes a first downstream liquid chamber configured to be at a hydrostatic position lower than the nozzle and connected to the inkjet head.

9. The ink ejecting apparatus according to claim 8, wherein the upstream supply port is on a side wall of the first upstream liquid chamber.

10. The ink ejecting apparatus according to claim 8, wherein the upstream tank includes an upstream partition plate that separates the first upstream liquid chamber and the second upstream liquid chamber.

11. The ink ejecting apparatus according to claim 8, wherein the downstream tank further includes:
a second downstream liquid chamber connected to the first downstream liquid chamber;
a downstream air chamber that is connected to the first downstream liquid chamber and the second downstream liquid chamber;
a downstream supply port on the first downstream liquid chamber and connected to the inkjet head; and
a downstream drain port on the second downstream liquid chamber and connected to the main tank.

12. The ink ejecting apparatus according to claim 11, wherein
the downstream tank includes a partition plate that separates the downstream tank into the first downstream liquid chamber and the second downstream liquid chamber, and
the downstream supply port is disposed on a side wall of the first downstream liquid chamber.

13. The ink ejecting apparatus according to claim 8, wherein a connector tube for fluidly connecting the upstream tank to the inkjet head and a connector tube for fluidly connecting the inkjet head to the downstream tank are identical in length and diameter.

14. The ink ejecting apparatus according to claim 8, further comprising a filter connected between the pump and the first upstream liquid chamber, the filter being configured to remove impurities from liquid.

15. An ink ejecting apparatus, comprising:
an inkjet head having a nozzle;
a main tank that stores ink;
an upstream tank connected to an upstream side of the inkjet head;
a downstream tank connected to a downstream side of the inkjet head; and
a pump configured to supply the liquid from the main tank at an amount larger than a sum of an amount of liquid passing through the inkjet head and an amount of liquid ejected from the inkjet head, wherein
the upstream tank includes:
first, second, and third upstream liquid chambers, which are connected to an upstream air chamber, the first upstream liquid chamber configured to be at a hydrostatic position higher than a nozzle of the inkjet head, the second upstream liquid chamber being adjacent to the first upstream liquid chamber, and the third upstream liquid chamber being adjacent to the second upstream liquid chamber;
an upstream supply port on the first upstream liquid chamber and connected to the pump, the upstream supply port being below an uppermost portion of the first upstream liquid chamber;
an upstream delivery port on the second upstream liquid chamber and connected to the inkjet head; and
an upstream drain port on the third upstream liquid chamber and connected to the main tank, and
the downstream tank includes:
first and second downstream liquid chambers, which are connected to a downstream air chamber, the first downstream liquid chamber configured to be at a hydrostatic position lower than the nozzle surface, and the second downstream liquid chamber connected to the first downstream liquid chamber;
a downstream supply port on the first downstream liquid chamber and connected to the inkjet head; and
a downstream drain port on the second downstream liquid chamber and connected to the main tank.

16. The ink ejecting apparatus according to claim 15, wherein the upstream supply port is on a side wall of the first upstream liquid chamber.

17. The ink ejecting apparatus according to claim 15, wherein the upstream tank includes an upstream partition plate that separates the first upstream liquid chamber and the second upstream liquid chamber.

18. The ink ejecting apparatus according to claim 15, wherein
the downstream tank includes a partition plate that separates the downstream tank into the first downstream liquid chamber and the second downstream liquid chamber, and
the downstream supply port is disposed on a side wall of the first downstream liquid chamber.

19. The ink ejecting apparatus according to claim 15, wherein a connector tube for fluidly connecting the upstream tank to the inkjet head and a connector tube for fluidly connecting the inkjet head to the downstream tank are identical in length and diameter.

20. The ink ejecting apparatus according to claim 15, further comprising a filter connected between the pump and the first upstream liquid chamber, the filter being configured to remove impurities from liquid.
